(19) United States
(12) Patent Application Publication
(10) Pub. No.: US 2017/0251377 A1
(43) Pub. Date: Aug. 31, 2017

(54) METHOD AND SYSTEM FOR NEIGHBOR TIER DETERMINATION

(71) Applicant: NOKIA SOLUTIONS AND NETWORKS OY, Espoo (FI)

(72) Inventors: Eamonn GORMLEY, Bothell, WA (US); Dan WELLINGTON, Bothell, WA (US)

(21) Appl. No.: 15/512,908

(22) PCT Filed: Sep. 25, 2015
(86) PCT No.: PCT/US15/52482

§ 371 Date: Mar. 21, 2017

Related U.S. Application Data
(60) Provisional application No. 62/055,583, filed on Sep. 25, 2014.
(60) Provisional application No. 62/055,580, filed on Sep. 25, 2014.

(51) Int. Cl. H04W 16/18; H04W 24/02

(52) U.S. Cl. CPC H04W 16/18; H04W 24/02; H04W 88/08

(57) ABSTRACT

A computer-implemented method for determining a neighbor tier relationship between first and second cells in a wireless communications network that includes a plurality of cell sites includes establishing respective cell site shapes for the plurality of cell sites including the first and second cells, each shape representing a coverage area of a corresponding cell site, establishing cell shapes for the cells of the plurality of cell sites, determining a tier relationship between the first and second cells based on a number of cell polygons between the first and second cells, and storing the tier relationship in a memory. The tier relationship may be used to support various cellular activities such as ANR and reuse code disambiguation routines.

### CROSS-REFERENCES TO RELATED APPLICATIONS

The present invention claims priority to U.S. Provisional Application No. 62/055,580, filed Sep. 25, 2014, and U.S. Provisional Application No. 62/055,583, filed Sep. 25, 2014, which are incorporated by reference herein for all purposes.

### BACKGROUND

In order to serve the increased demand, wireless communication networks are becoming more diverse and complex, and subsequently are becoming more difficult to manage. A Self-Organizing Network (SON) simplifies and automates multiple processes to efficiently manage diverse communication networks.

Many SON algorithms require information about the coverage areas of cells in order to make better optimization decisions. However, it can be difficult to obtain cell coverage information for a network. Cell coverage information could be retrieved from the output of a network planning tool, but this information is not always available to a SON tool. In addition, network planning tools tend to use large amounts of data to determine cell coverage, so planning tools tend to be relatively slow and inefficient.

Typical algorithms attempt to estimate the coverage area of a source cell by identifying the closest cells in the network to the source cell and using information on the azimuth of the source cells to estimate a coverage distance for that cell. While these methods can produce acceptable results in networks where cells are laid out in a regular fashion, they tend to perform poorly in areas with an irregular placement of cells.

In addition, some algorithms have absolute distance thresholds in place to prevent against poor algorithmic decisions. For example, an Automated Neighbor Relations (ANR) algorithm may impose a maximum distance threshold beyond which cells are not added to neighbor lists. One problem with imposing such a threshold is that a single threshold is generally not suitable in all cases, especially when cell density varies.

For example, in rural environments, a large distance threshold such as 15 km may be suitable. However, if this threshold is used in an urban environment, distant cells may be added to the neighbor list of a source cell, resulting in poor system performance. In an urban environment, a distance threshold of 2 km to 4 km may be more suitable. However, if the distance threshold is set too low, neighbor cells may not be added, even though manual inspection shows that they should be.

Distance thresholds are generally applied to a large number of cells in a region such as all cells on a particular Radio Network Controller (RNC). While different distance thresholds may be applied on a per-cell basis, this is time consuming and error prone if done manually.

In practice, optimization engineers don't consider distances—instead, they look at cell tiers. Most RF engineers look at map and intuitively know how many tiers separate cells. However, it can be hard for an optimization engineer to provide a precise definition for a cell tier, or how to establish such a tier.

Most engineers will look at a map and make intuitive estimates about which cells are first tier neighbors of a source cell. Generally, these will be the closest cells to the source cells, with antenna pointing directions that are pointing towards the coverage area of the source cell. However, these intuitive decisions are difficult to translate into algorithms. Therefore, it is desirable to have an accurate and efficient tool that automates the tier counting process.

### BRIEF SUMMARY

In an embodiment of this disclosure, A computer-implemented method for determining a neighbor tier relationship between first and second cells in a wireless communications network that includes a plurality of cell sites includes establishing respective cell site shapes for the plurality of cell sites including the first and second cells, each shape representing a coverage area of a corresponding cell site, establishing cell shapes for the cells of the plurality of cell sites, determining a tier relationship between the first and second cells based on a number of cell polygons between the first and second cells, and storing the tier relationship in a memory.

In an embodiment, establishing cell shapes for the cells of the plurality of cell sites includes determining cell points for cells of the plurality of cell sites and creating a second Voronoi diagram using the cell points as seeds. Establishing respective cell site shapes for the plurality of cell sites may include determining locations for each of the plurality of cell sites and creating a first Voronoi diagram using the cell site locations as seeds.

The method may further include determining cell points for cells of the plurality of cell sites. In such an embodiment, determining cell points for cells of the plurality of cell sites may includes determining a distance from a first cell site of the plurality of cell sites to a nearest neighboring cell site and establishing cell points for the first cell site at locations that are a fraction of the distance from the first cell site. The fraction of the distance may be a value from 0.05 to 0.50, and the cell points may be established at azimuth directions for antennas of the first cell site. Furthermore, the nearest neighboring cell site may be determined by performing Delaunay triangulation on the plurality of cell sites,

In an embodiment, the method may further include performing Delaunay triangulation on the cell points. Such an embodiment may further include determining first tier relationships between cells associated with the cell points by identifying cells that are connected by a single leg of triangles from the Delaunay triangulation as first tier neighbors. In addition, determining first tier relationships may be performed for all cells of the plurality of cell sites, and it may further include counting a number of first tier relationships between the first cell and the second cell, wherein the number of first tier relationships is the tier relationship between the first cell and the second cell.

In an embodiment, determining the tier relationship between the first and second cells includes determining a least number of triangle legs of the Delaunay triangles that connect the first cell to the second cell. The cell shapes and/or the cell site shapes may be Voronoi polygons. In an embodiment, the tier relationship between the first cell and the second cell is determined based on a lowest number of Voronoi polygons between the first and second cells.

Tier counting may include determining a lowest number of polygon edges that must be traversed between the first cell and the second cell, wherein the lowest number of polygon edges is a value of the tier relationship between the first and second cells.

In an embodiment, tier counting includes establishing a line between one of first or second cell points corresponding to the first and second cells or first or second cell sites corresponding to the first and second cells and determining a number of cell shapes that intersect with the line, wherein the number of cell shapes that intersect with the line is a value of the tier relationship between the first and second cells.

When a cell site uses an omnidirectional antenna, the cell point may be the location of the cell site. A method may further include updating a neighbor list based on the tier relationship.

### BRIEF DESCRIPTION OF THE DRAWINGS

FIG. 1 illustrates a wireless communications system according to an embodiment.

FIG. 2 illustrates a network resource controller according to an embodiment

FIG. 3 illustrates an automatic tier counting process according to an embodiment.

FIG. 4 illustrates a process for establishing a shape around a cell site.

FIG. 5A illustrates site locations as shapes in a regular deployment.

FIG. 5B illustrates site locations as shapes in a variable density deployment.

FIG. 6 illustrates a process for determining tier relationships between cells.

FIGS. 7A, 7B and 7C illustrate determining tier relationships between cells.

FIG. 8A is a Voronoi diagram of cell sites, and FIG. 8B is a Voronoi diagram of cell points.

FIG. 9 illustrates a process for determining tier relationships between cells.

FIGS. 10A and 10B illustrate determining tier relationships between cells.

FIGS. 11A and 11B illustrate determining shapes based on cell type.

FIG. 12 illustrates a process for determining tier relationships between cells.

FIGS. 13A and 13B illustrate determining tier relationships between cells.

FIG. 14 illustrates a process for determining tier relationships between cells.

FIG. 15 illustrates tier relationships between cells.

FIG. 16 illustrates a process for determining tier relationships between cells.

FIG. 17 illustrates tier relationships between cells.

FIG. 18 illustrates a process for determining tier relationships between cells.

FIG. 19 illustrates a process for determining tier relationships between cells.

FIG. 20 illustrates determining tier relationships between cells.

### DETAILED DESCRIPTION

In the following description, neighbor tiers are related to coverage area boundaries. In particular, two neighboring cells are first tier neighbors when their respective coverage areas share a common cell boundary. In addition, second tier neighbors have coverage areas that are separated by one other cell, while third tier neighbors have coverage areas that are separated by two other cells, and so on. This explanation is consistent with expectations from RF engineers for tier relationships.

This disclosure provides a method and system for determining the number of tiers separating cells in a cellular communications network. This information can then be used in algorithms for self-organizing networks, such as Automatic Neighbor Relations (ANR), Neighbor List Initialization, Coverage and Capacity Optimization (CCO), Reuse Code Optimization (e.g., Scrambling Code Optimization for UMTS networks, PCI Optimization for LTE Networks, BSIC optimization for GSM networks, etc.). Various cellular parameters may be changed in conjunction with these activities, such as transmit power and antenna tilt and direction.

A detailed description of embodiments is provided below along with accompanying figures. The scope of this disclosure is limited only by the claims and encompasses numerous alternatives, modifications and equivalents. Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

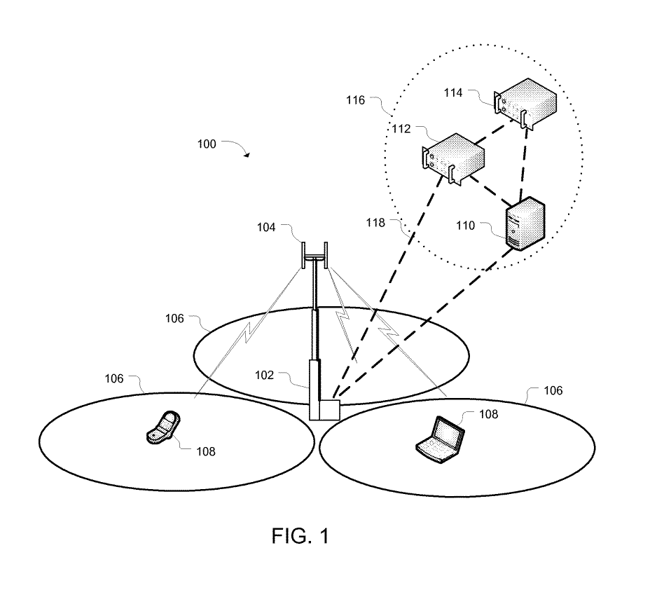

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment 108 in one or more cells 106. As used herein, the term “base station” refers to a wireless communications station provided in a location and serves as a hub of a wireless network. For example, in LTE, a base station may be an eNodeB. The base stations may provide service for macrocells, microcells, picocells, or femtocells. In this disclosure, the term “cell site” may be used to refer to the location of a base station.

The one or more UE 108 may include cell phone devices, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment 110, 112 and 114 and the one or more base station 102. As would be understood by those skilled in the Art, in most digital communications networks, the backhaul portion of the network may include intermediate links 118 between a backbone of the network which are generally wire line, and sub networks or base stations located at the periphery of the network. For example, cellular user equipment (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 102 of the system 100 of FIG. 1 may employ any of the following common communications technologies: optical fiber, coaxial cable, twisted pair cable, Ethernet cable, and power-line cable, along with any other wireless communication technology known in the art. In context with various embodiments of the invention, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided remotely from the base stations or provided at the base station. Any of the network controller devices 110, 112 and 114 may be a non-dedicated device that provides NRC functionality among others. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a NRC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. Any of the network controller devices 110, 112 and 114 or any of the base stations 102 may employ any number of common server, desktop, laptop, and personal computing devices.

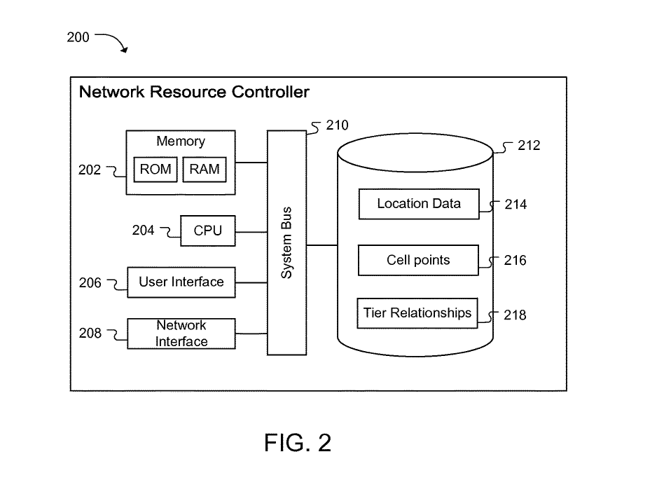

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), or a SON server. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, location data 214, cell points 216, and tier relationships 218.

The NRC 200 may also include a user interface 206 that allows an administrator to interact with the NRC's software and hardware resources and to display the performance and operation of the system 100. In addition, the NRC 200 may include a network interface 206 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

Neighbor tier counting is facilitated by establishing boundaries for individual cells. Determining the coverage area of each cell facilitates establishing cell boundaries. There are a number of ways in which this can be accomplished.

Cell boundaries can be established using an RF planning tool or from measurements in a deployed network, such as drive test measurements or data from a geolocation tool. RF planning tools can make a determination of which cells are first tier neighbors of each other. Second, third and subsequent tier neighbors may be determined through various relationships. However, this level of RF planning tool information is not always available to a SON tool, and even when it is, the amount of time and resources, including processor resources, for providing such information makes it difficult to provide current coverage information in a timely manner. In addition, in the case of a customer trial, operators may be reluctant to provide information from their planning tools, which typically includes sensitive data.

Drive test and Geolocation data could be used to make determinations of cell coverage area. However, there are drawbacks to making tier determinations using drive test or geolocation information. For example, such information requires that networks be already deployed. However some SON algorithms (e.g., neighbor list initialization) use neighbor tier separation data prior to a cell being deployed. Thus, this data is not available in some situations.

Drive test data requires physical presence in various geographic locations which may not be practically accessible. Accordingly, drive test data is generally not available for all parts of the network. In addition, an operator may not have deployed a geolocation solution in their network.

On the other hand, SON tools are generally provided with cell site information such as cell location including cell latitude and longitude, whether cell is deployed indoors or outdoors, antenna azimuth (pointing direction), and antenna height information. Using this information alone, it is possible to make an estimate of cell coverage areas and use this information to determine cell boundaries, first tier neighbor cells, etc. Embodiments of such a process and a system that implements the process are provided by this disclosure.

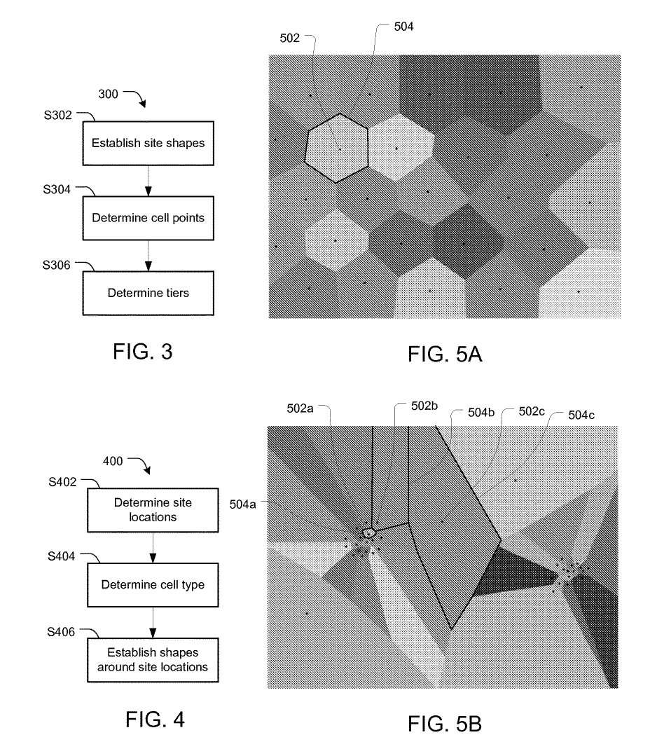

FIG. 3 illustrates a general process 300 for determining neighbor tier relationships for cells. Elements of process 300 will be explained in more detail with respect to subsequent figures and processes.

In process 300, shapes are established at S302 for cell sites, which may correspond to the location of a base station, such as a cellular tower for a macrocell. The cell site shapes may be used to establish cells S304, which may be represented as points, shapes, or both in various embodiments. For example, a cell point may be a centroid of a cell shape, a base station location for cases such as a femtocell with an omnidirectional antenna, or a point a certain distance along an azimuth from a base station. In an embodiment with an omnidirectional antenna, a site shape may be the same as a cell shape. After cells are established, neighbor tier relationships between cells are determined at S306.

FIG. 4 shows a process S400 for establishing a shape around a cell site. Locations for cell sites in a cellular network are determined at S402. A location for a cell site may be latitude and longitude values for the cell site. The cell site locations may be maintained in a database, which may be a pre-existing database of a SON server in a specific embodiment. Such a database may be updated as new cell sites are deployed, and processes according to embodiments of this disclosure may be performed periodically so that neighbor tier relationships are accurate as the network evolves.

Network planning teams generally select cell sites to have a coverage area in all directions around the cell site. This is particularly true for Macro cell deployments. Typically, the locations closest to a cell site are served by that cell site.

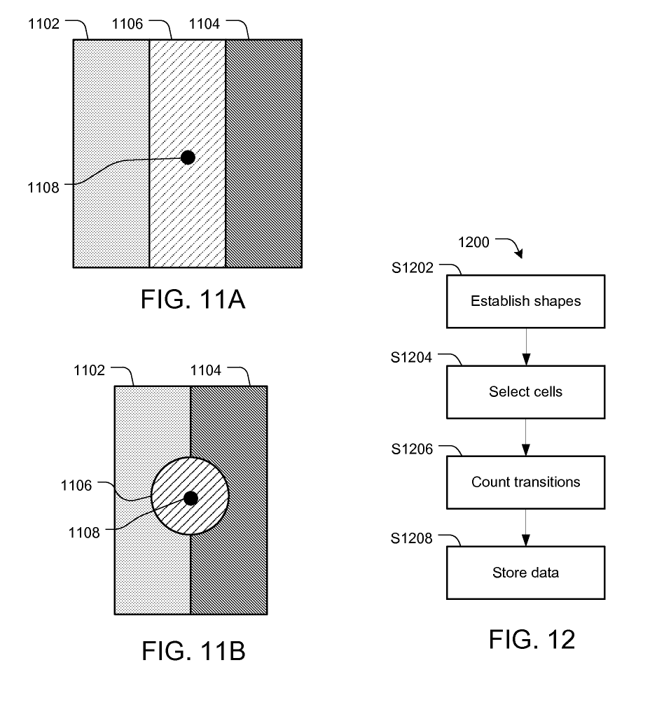

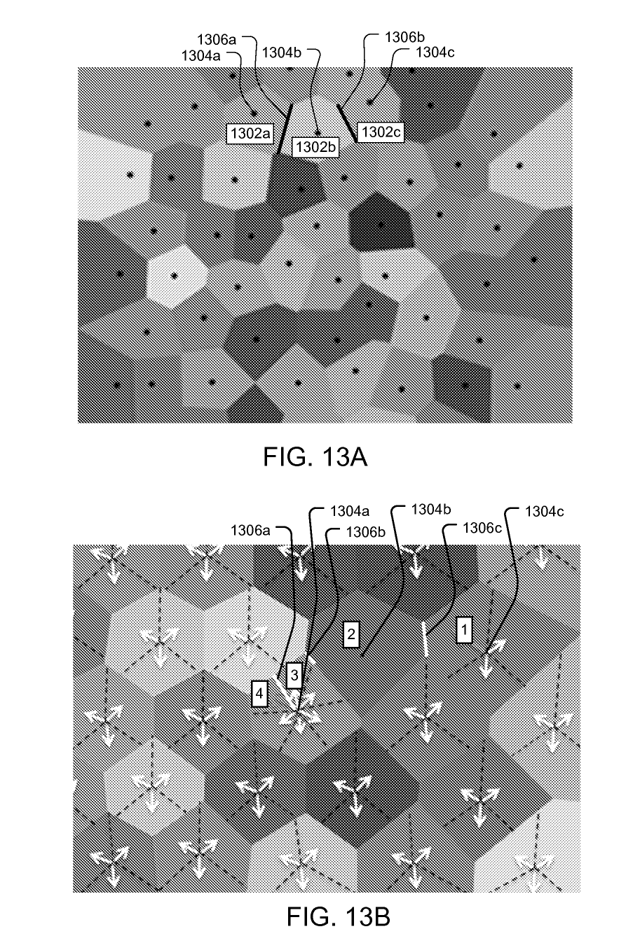

Cell types for the cell sites are determined at S404. Various types of cells have different characteristics, and an embodiment may account for one or more characteristic when creating a shape for the site at S406. For example, the coverage area of a femtocell is substantially smaller than the coverage area of a macrocell, so different techniques may be employed when establishing a femtocell shape compared to establishing a macrocell shape. Examples of how cell types may influence establishing shapes S406 are provided in more detail below with respect to FIGS. 11A, 11B and 13A.

Shapes are established around the site locations at S406. Establishing shapes S406 will be explained with respect to FIG. 5A, which shows shapes in a regular (e.g. evenly spaced) deployment, and FIG. 5B, which shows a deployment with varying site density. The shapes in FIGS. 5A and 5B Voronoi polygons established using Voronoi diagrams.

For a given set of points, a Voronoi diagram divides an area into regions around a plurality of points, or seeds, in such a way that each point in a region is closest to its seed. If the seeds are cell sites, then resulting regions are polygons that provide a useful approximation of the coverage area of a cell site. While the resulting polygons are not exact representations of the coverage area of each site, the boundary of the polygons can be used as indication of the first tier neighbor sites of each site.

An example of a set of sites 502 and the Voronoi polygons 504 for those sites is shown in FIG. 5A. Depending on the layout of the sites 502, the polygons may have various numbers of sides. Highly efficient algorithms have been developed for creating Voronoi polygons around data points, which can be employed in embodiments of this disclosure.

FIG. 5B shows a Voronoi diagram of a variable density site scenario. This example is representative of a high density site deployment around two small urban areas, with rural sites in between.

FIG. 5B illustrates an advantage of an embodiment of this disclosure over a distance-based approach. While a distance-based approach may recognize that site 502a is a neighbor of site 502b, the distance-based approach may not recognize that site 502c is a neighbor of site 502b because there is a substantial distance between them. However, for mobility purposes, site 502c is a first-tier neighbor of site 502b, and cells associated with site 502c will accept handovers from cells associated with site 502b.

In the Voronoi diagrams of FIG. 5A and FIG. 5B, first tier site neighbors are those that share a common polygon edge. Second tier neighbors are those that have a common first tier neighbor, and so on.

Instead of calculating polygon edges, the first tier neighbors can be determined via Delaunay triangulation. For a first point (site) 502, Delaunay triangulation directly provides the points (sites) 502 that have Voronoi polygon edges that are adjacent to the polygon edges of the first point.

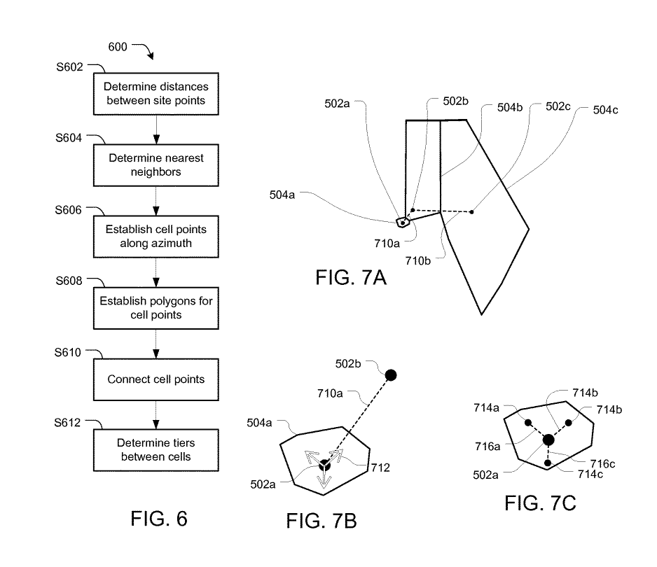

FIG. 6 shows a process 600 for determining tier relationships between cells. In process 600, distances between site points are determined at S602. FIG. 7A shows the three cell sites 502a, 502b and 502c from FIG. 5. In FIG. 7A, the distance between cell sites 502a and 502b is represented by line 710a, and the distance between sites 502b and 502c is represented by line 710b.

In an embodiment, determining distances between site points may be accomplished by performing Delaunay triangulation to all site locations in a network area. The resulting mesh from a Delaunay triangulation of the site points may effectively determine distances between all neighboring cell sites, where a length of a triangle leg between points corresponds to a distance between the points.

The nearest neighbor site for each cell site may be determined at S604. Such a determination may be made, for example, by comparing the lengths (distances) of all triangle legs from a Delaunay triangulation with a vertex at a target cell site. For example, if cell site 502b of FIG. 7A is a target site, then comparing 710a to 710b returns a result that the nearest neighbor is cell site 502a. For convenience, this disclosure may represent the distance to the nearest neighbor of a target cell site as variable dminSite.

A typical cellular telecommunications network includes a large number of eNodeB base stations as cell sites. An eNodeB base station is typically configured to provide three co-sited cells for a given set of frequencies to establish 360 degrees of coverage around the base station. Accordingly, an eNodeB typically has three antennas to serve the co-sited cells, and each antenna has an azimuth that is separated from azimuths of the other two antennas.

Cell points 714 are established along azimuth lines of each cell site 502 at S606. If cell points are chosen so that they are equidistant from the site location, then when Voronoi polygons are subsequently provided for the cell points, the resultant polygon edges between adjacent cells at the same site will bisect the azimuths of each cell. If the cell points are close to the site point, then the resulting polygons from the Voronoi diagram of the cell points are similar to segmented versions of the site polygons. If the cell points overlap the site point, then the polygons of the cell points will be very similar to a polygon of the site point.

A suitable distance for locating cell points along azimuth lines at S606 may be determined by finding the closest first tier site and taking a fraction of this distance. In general, the fraction should be less than 0.5, which is half of the distance dminSite between the site and its closest first tier neighbor site, in order to avoid locating the cell point in the coverage area of an adjacent cell. Values from 0.05 to 0.3 have been found to work well in practice. Each cell point is then set along the azimuth line of that cell, where the distance from the site 502 is the chosen fraction of the distance between the site 502 and the site of its closest neighbor (dminSite).

FIGS. 7B and 7C illustrate some of the elements of steps S604 and S606. For example, FIG. 7B shows a polygon 504a for cell site 502a, and line 710a represents the distance dminSite between cell site 502a and cell site 502b as shown in FIG. 7A. In addition, FIG. 7B shows cell azimuth directions 712, which are represented by arrows oriented in the respective pointing directions of three corresponding antennas of cell site 502a.

FIG. 7C shows a result of performing process S606 to the embodiment of FIG. 7B. In particular, cell points 714a, 714b and 714c are established at distances along the azimuth lines 716a, 716b and 716c, respectively. The distances used in FIG. 7C correspond to about 0.25, or 25%, of the original distance dminSite of minimum distance 502b.

In another embodiment, different cell points of a cell site may be located at different distances from the cell site origin. For example, consider FIG. 7A, in which cell site 502b is neighbored by site 502a in one direction and site 502c in another direction. Cell site 502c is substantially farther from site 502b than site 502a. In order to account for this discrepancy, an embodiment may use different dminSite values for each azimuth of a cell site 502.

For example, an embodiment may determine a nearest neighbor from neighboring sites that are found within an arc segment centered around an azimuth line and projecting outward from the origin cell site, and determine different dminSite values based on distances to neighbors for each separate azimuth. Such an embodiment may be employed, for example, when neighbor tiers are counted using ray trace techniques or other techniques that are more sensitive to cell point shapes than relational techniques such as edge sharing techniques.

Shapes are created around cell points at S608. Creating shapes around cell points may be performed by establishing Voronoi polygons using cell points as the seed values for the polygons.

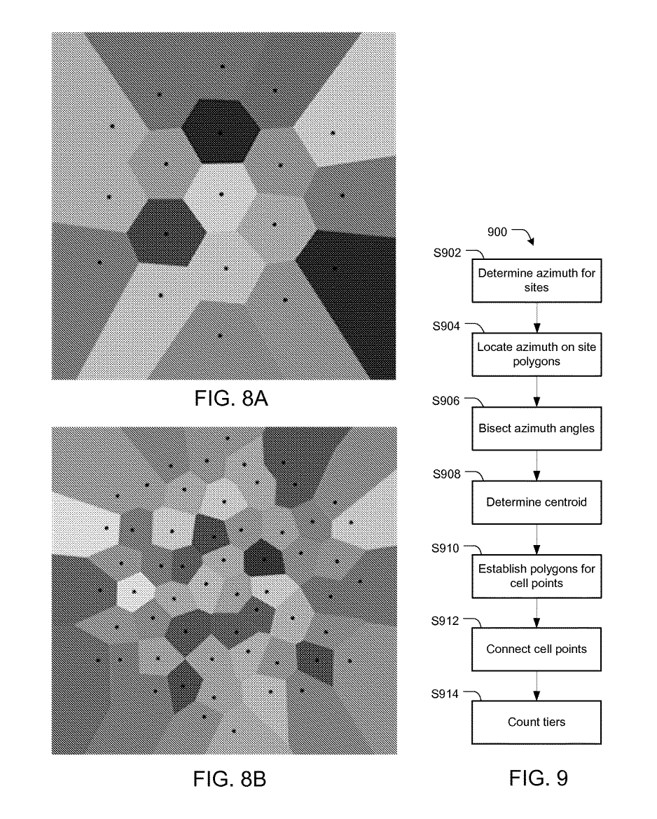

FIGS. 8A and 8B show a difference between a Voronoi diagram for cell sites and a Voronoi diagram for cell points. In particular, FIG. 8A is a Voronoi diagram showing Voronoi polygons around a plurality of cell sites. FIG. 8B is a cell point diagram that was established by determining distances to nearest neighbors for each cell site, projecting azimuth values onto the cell site locations of FIG. 8A, and locating cell points at a fraction of 0.25 of the minimum neighbor distance dminSite along the azimuth lines for each site. In other words, FIG. 8A represents a result of an embodiment of a process 400, while FIG. 8B represents a result of an embodiment of step S608 of process S600.

Depending on the technique employed for tier counting, certain embodiments may not perform step S608. For example, triangulation techniques establish links between cell points, so it may not be necessary to establish shapes for cell points when tiers are counted using triangulation. In contrast, ray trace and shared edge techniques use polygons for cell points to determine tier relationships.

Cell points may be connected to one another at S610. In an embodiment, each cell point is connected to its nearest neighbors using Delaunay triangulation. Delaunay triangulation is a useful technique for establishing connections between neighboring cells in the same way that network engineers understand neighbor relationships. Delaunay triangulation is useful to automate a process that returns meaningful and accurate results.

Tier relationships between cell points are determined at S612. Embodiments of determining tier relationships are discussed in detail below.

FIG. 9 illustrates an embodiment of a process 900 for determining tier relationships between cells that is a different from process 600 of FIG. 6. At S902, azimuth values are determined for cell sites. As discussed above, a macrocell site typically serves three cells, so when a site is a macrocell site, S902 may determine three azimuth directions. In an embodiment, azimuth values for a cell site are determined by retrieving data from a database of azimuth directions.

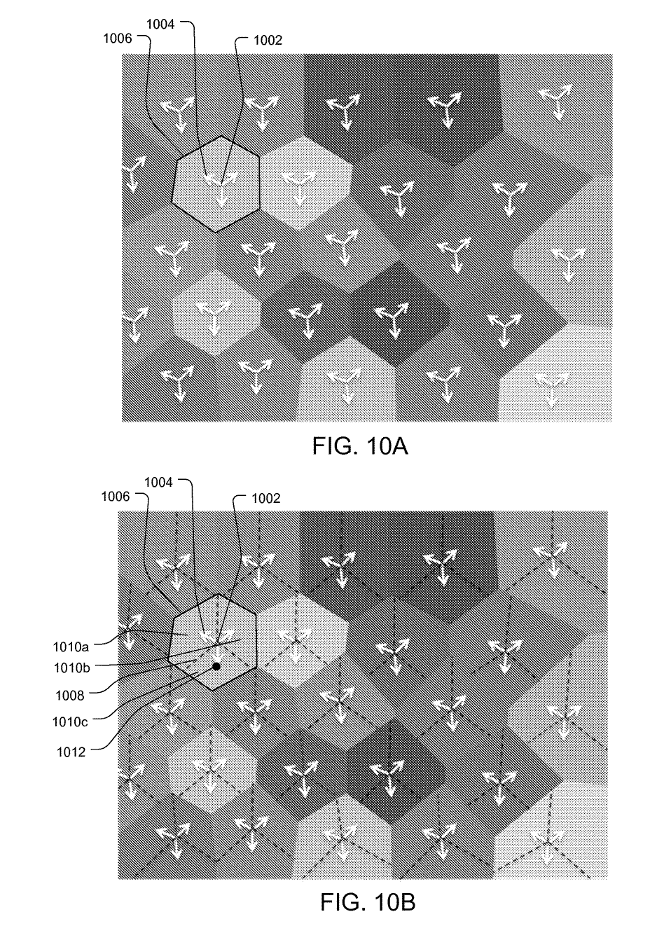

The azimuth directions are located on a site polygon at S904. FIG. 10A shows azimuths 1004, which are represented as rays emanating in different directions from the cell site location 1002, projected onto a site polygon 1006. In an embodiment, azimuth lines 1004 are extended to the edges of polygons 1006. However, the angular component of the azimuth is used at S906, so embodiments may project rays emanating in directions from cell sites 1002 instead of lines with two points. Although there are three arrows in azimuths 1004 which represent a typical macrocell site, other macrocell sites may serve different numbers of cells, so the numbers of azimuth rays may be adapted to correspond to the number of cells served by a site within a particular technology and frequency range.

As seen in FIG. 10B, angles between two adjacent azimuth rays 1004 are bisected by lines 1008 at S906, which are shown as dashed lines in the figure. Bisecting the azimuths 1004 can be may be accomplished by determining an angle between two azimuth rays, and establishing line 1008 at an angle that is about halfway between the two azimuth rays, with endpoints of the line at the cell site 1002 and an edge of the site polygon 1006. The polygons 1010 that result from S906, which include lines defining the edges of site polygon 1006 and the bisected azimuth lines 1008, are representative of cells that are served by cell site 1002. The cell polygons around cell site 1002 are represented as polygons 1010a, 1010b, and 1010c in FIG. 10B.

In an embodiment, a centroid 1012 is established for each respective cell polygon 1010 at S908. The centroid 1012 for a cell polygon 1010 may represent a cell point for the polygon.

After centroids 1012 are established at S908, polygons may be established for the cell points 1012 at S910 by creating a Voronoi diagram of the cell points. However, other embodiments may not perform S910, and may count tiers based on cell polygons 1010 from S906 or centroids 1012. Similarly, cell points may optionally be connected at S912 by Delaunay triangulation depending on the manner in which tiers are counted. Tiers are then counted at S914, for example by counting shared edges, ray tracing, etc.

In FIGS. 10A and 10B, each base station provides three cells, as indicated by the three azimuth directions 1004. However, some cell sites do not have three antennas. For example, sites for femtocells may have an omnidirectional antenna, while other cell sites may provide other numbers of cells. Accordingly, processes and systems according to this disclosure may determine a type of base station associated with cell types and apply rules to process 600 or process 900 that are specific to the cell type.

Processes 600 or 900 may be applied to all cells in a network. This may lead to an over-estimate of the number of tiers between cells in some cases. When smaller cells with less than 360 degree coverage, or indoor cells are also deployed in a network, then different processes may be applied when establishing shapes for such cell sites at S406. For example, in some embodiments, different shapes or weighting may be used for certain types of cells.

For example, if there is a Pico cell between two Macro cells, then typical a Voronoi diagram makes the Pico cell first tier neighbors of each Macro cell, but may make the macro cells second tier neighbors of each other, when they should be first tier neighbors. Such an embodiment is shown in FIGS. 11A and 11B.

FIG. 11A shows an embodiment of a Voronoi diagram of shapes around cell points 1108. The shape 1106 in the middle represents a pico cell with low transmit power, and the polygons 1102 and 1104 on the left and right represent macro cells. The resulting Voronoi diagram is as shown in FIG. 11A.

The situation in FIG. 11A may lead to an over-estimate of the number of tiers between two cells in some cases. FIG. 11A shows a result of applying Voronoi polygons to macrocells 1102 and 1104 as well as picocell 1106. However, the relationships in FIG. 11A may not accurately represent relationships between the cells from a user mobility perspective. For example, while FIG. 11A requires transiting across cell 1106 to move from cell 1102 to cell 1104, in an actual physical space, UE may handover from cell 1102 directly to cell 1104 without interacting with picocell 1106.

FIG. 11B illustrates a picocell 1106 located between two macrocells 1102 and 1104. As shown in FIG. 11B, the polygon representing cell 1102 shares edges with the polygon representing cell 1104. In an embodiment, sharing a shape edge indicates a first-tier neighbor relationship. Accordingly, the embodiment of FIG. 11B is a more accurate representation of cell tier relationships than FIG. 11A. In another embodiment, when the cell site 1108 for picocell 1106 is closer to a cell site of a macrocell, the circle representing picocell 1106 in FIG. 11B may be located entirely within an area of a macrocell shape, representing a relationship in which the picocell is only a first tier neighbor to that macrocell.

FIG. 11B shows an example of establishing a circular shape for a cell site at S406 when S404 determines that the cell type of cell site 1108 is a picocell. The shape used to represent omnidirectional antennas may be a circle. Other embodiments may use various shapes to more accurately represent coverage areas of different types of base stations and deployment scenarios. Other shapes that may be used for these cells include a wedge shape, a triangle, a circle, an oval, and combinations of these and other shapes.

Specific shapes may be applied to certain cell types and deployment scenarios separately from creating polygons for other cells using a Voronoi diagram at S406. For example, an embodiment of S406 may include first establishing Voronoi polygons for macrocells, and second applying specific shapes, which may be weighted polygons.

In some embodiments, weighting may be applied based on a cell type or a deployment scenario. Weighting may be applied to a general polygon from a Voronoi diagram, or a specific shape for a cell type. Factors that may be used to apply weighting to a shape include the type of cell, the transmit power, the antenna height, and location characteristics, such as whether the cell site is indoors or outdoors.

Weighting may be applied in many different ways. In an embodiment, cell weights may be scaled to a coverage area or transmit power of a cell type. For example, a macrocell may be weighted more than a microcell, which may in turn be weighted more than a picocell. Other characteristics that may be assigned different weights include power, antenna height, and environment. For example, higher power cells may be weighted more than lower power cells, higher antenna heights may be weighted more than lower antenna heights, and outdoor deployments may be weighted more than indoor deployments. Persons of skill in the Art will recognize that other cell characteristics can influence the size of representative shapes in other embodiments.

In another embodiment, one or more cell shape may be established using a power diagram. The size of shapes in the power diagram may be adapted according to weighting based on cell characteristics as described above. The weighting may be applied through a multiplicatively weighted diagram, and additively weighted diagrams may be suitable as well.

Other cell characteristics that may be evaluated to determine a shape and/or a size of a shape include the Radio Access Technology (RAT) and frequency layers of a cell. In general, the neighbor tiers will be determined for cells of a particular RAT (e.g., GSM, UMTS, LTE) that operate on the same frequency. However, depending on the application, neighbor tier counting can also be implemented for cells of different types. For example, first tier inter-RAT neighbors may be determined using the approaches in this disclosure by calculating the Delaunay triangulation and/or Voronoi polygons for cells of another technology.

FIG. 12 illustrates a process 1200 for determining a tier relationship between two cells. FIG. 12 is an example of counting tiers, and corresponds to S914, S612 and S306.

Shapes are established at S1202. In one embodiment, shapes are established in accordance with S608 as Voronoi polygons around cell points. In another embodiment, shapes are established by bisecting azimuth lines of cell sites in accordance with S910. Accordingly, process 1200 may be performed using shapes that were established from various embodiments.

Cells for which tier relationships are determined are selected at S1204. Tier relationships may be determined for all cells in a network, for cells in a particular area, or for two or more specific cells. Thus, two or more cells may be selected at S1204.

In an embodiment, when a new cell is installed, tier relationships for the new cell and its neighbors may be determined. In addition, a new cell may affect tier relationships for pre-existing cells in an area around the new cell. Therefore, tier relationships for all cells in an area around a new cell may be selected at S1204.

One way of counting the tiers between neighbor cells is to find the minimum number of cells that have to be traversed to get from the coverage area of a first cell to the coverage area of a second cell. This may be accomplished, for example, by counting transitions between cells at S1206. An embodiment of counting transitions between cells is shown in FIG. 13A.

FIG. 13A shows a plurality of cell shapes 1302 that are established around cell points 1304. In FIG. 13A, neighbor tier relationships are determined between a first cell corresponding to cell shape 1302a and a second cell corresponding to cell shape 1302c. There are two cell shape boundaries 1306 between first cell shape 1302a and second cell shape 1302c. Each of the cell shape edges 1306 corresponds to a transition between adjacent cells. Therefore, performing S1206 on cells 1302a and 1302b results in a single transition, or cell shape edge 1306a, between the cells, so cell 1302a is a first tier neighbor of cell S1302b.

Similarly, two cell shape edges 1306a and 1306b lie between cell shapes 1302a and 1302c. Accordingly, the cell that corresponds to cell shape 1302a is a second tier neighbor of the cell that corresponds to cell shape 1302c. In an embodiment, an efficient algorithm such as Dijkstra's algorithm may be employed to determine a minimum number of edges between selected cells at S1206.

After tier relationships are determined by counting transitions at S1206, the tier relationships are stored in a database at S1208. The tier relationships may be transmitted to and stored by network equipment, where it may subsequently be used to perform a variety of network activities. While tier relationships may be stored by a SON server at S1208, tier relationships may also be stored by other network equipment such as an RRM, a base station, and UE.

FIG. 13B shows another embodiment of process 1200 that includes two variations from three sectored macrocells. In particular, the base station that serves cell 2 uses an omnidirectional antenna, so cell 2 is represented as a single polygon around cell site 1304. Cell 1 is associated with a three sector macrocell site 1304c, but cells 3 and 4 are associated with a cell site 1304a that has six antennas that provide service for six respective cells. Therefore, six cell polygons are established around cell site 1304a.

Applying process 1200 to FIG. 13B, cells 1 and 4 are selected at S1204. S1206 counts three transitions 1306a, 1306b and 1306c between cells 1 and 4. The transitions are defined by cell shape boundaries. The tier relationship between cells 1 and 4 corresponds to the number of transitions, or boundaries, between the cells, so cell 1 is established as a third tier neighbor of cell 4.

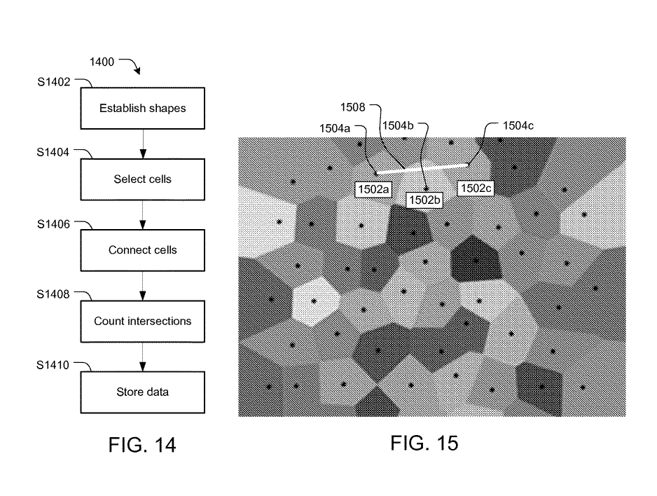

FIG. 14 shows a process 1400, which is another embodiment of determining a tier relationship between cells. Establishing cell shapes S1402 and selecting cells S1404 may be performed in the same fashion as S1202 and S1204 above, so a detailed description of these elements will be omitted for the sake of brevity.

The selected cells are connected at S1406. For example, FIG. 15 shows an example of a Voronoi diagram of a plurality of cell shapes 1502, in which cell shape 1502a and cell shape 1502c correspond to the selected cells. The selected cells are connected by a line 1508, which FIG. 15 shows as being projected onto a Voronoi diagram of cells in a network.

Although FIG. 15 shows the end points of line 1508 being cell points 1502, the end points of the line may be different in other embodiments. For example, in an embodiment in which cell site shapes are divided by lines bisecting azimuth directions, such as the embodiment shown in FIG. 10B, end points of a connecting line may be established at cell sites 1002. In another variation, centroids 1012 of cell shapes 1010 may be used as endpoints.

Intersections are counted at S1408. In particular, intersections between connection line 1508 and underlying cell shapes are counted. In FIG. 15, line 1508 intersects cell shapes 1502a, 1502b and 1502c, or three cell shapes. The tier relationship between selected cells is N−1, where N represents the number of cell shapes intersected by the line 1508 between cell points. Therefore, the cells corresponding to cell shapes 1502a and 1502c are determined to be second tier neighbors of one another. Tier data is then stored at S1410.

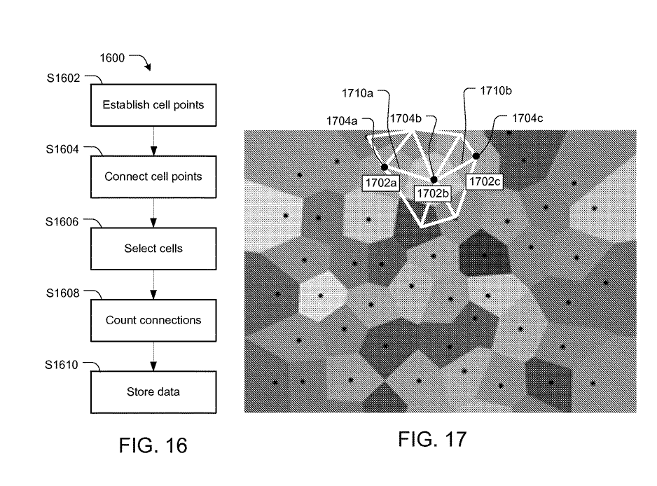

FIG. 16 shows a process 1600, which is another embodiment of determining a tier relationship between cells. Cell points are determined at S1602 as discussed above, and the cell points are connected at S1604.

FIG. 17 shows an embodiment in which cell points 1704 are connected to one another by lines 1710. In an embodiment, cell points may be connected to each other by performing Delaunay triangulation on an array of cell points. Delaunay triangulation is a useful technique for connecting cell points by establishing short paths between the cell points.

Cells for which a tier relationship is being determined are selected at S1606. In the embodiment of FIG. 17, cells 1702a and 1702c are selected. A number of connections between these cells is then determined at S1608. In particular, a least number of connections between cells may be determined.

For example, FIG. 17 shows that cell point 1702a can be connected to cell point 1702c through two connections 1710a and 1710b. Counting the number of connections at S1608 determines that two connections are present between the cell points. The least number of connections between cell points corresponds to a tier relationship between the cells, so process 1600 would determine that the cell associated with cell point 1704a is a second tier neighbor of the cell associated with cell point 1704c. This relationship may be stored at one or more device at S1610.

Depending on the activities that tier relationship data supports, it may be sufficient in some embodiments to know the exact number of tiers between cells when the cells are less than or equal to N tiers apart from each other, where N is an integer. If the cells are more than N tiers apart, then it may be sufficient to know they are more than N tiers apart, without knowing exactly how many tiers apart the cells are. In this case, it may be more efficient to pre-compute all the neighbors within the N tiers for each cell.

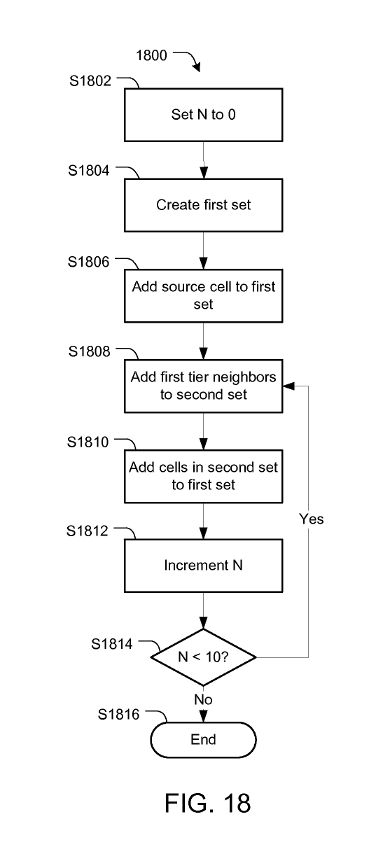

An example of a process 1800 for identifying neighbor relationships less than a certain value for a source cell is shown in FIG. 18. In process 1800, the cutoff value for tier relationships is 10.

Integer N is set to 0 at S1802. A first empty set that will be used to hold the first N tier neighbors is created at S1804. The source cell is added to the first set with a tier count attribute of 0 at S1806.

For cells already in the first set that have a tier count attribute equal to N, their first tier neighbors are placed into a second set at 1808. A second set is created for first tier neighbors of cells already in the first set that have a tier count attribute equal to N at S1808. So first tier neighbors of the source cell will be placed in the second set when N=0. Cells in the second set that are not already in the first set are added to the first set at S1810 with a tier count attribute of N+1, and N is incremented by +1 at S1812. S1808 to S1812 are repeated until a specified tier value is reached, which is 10 at S1814 in FIG. 18. Accordingly, process 1800 counts a number of first tier relationships for a first cell, and when compared to a second cell, effectively counts a number of first tier relationships between the first cell and the second cell.

Thus, performing process 1800 will identify all cells that have a neighbor tier relationship of less than or equal to a certain value for a source cell. Process 1800 is provided for illustrative purposes, and other specific embodiments are possible.

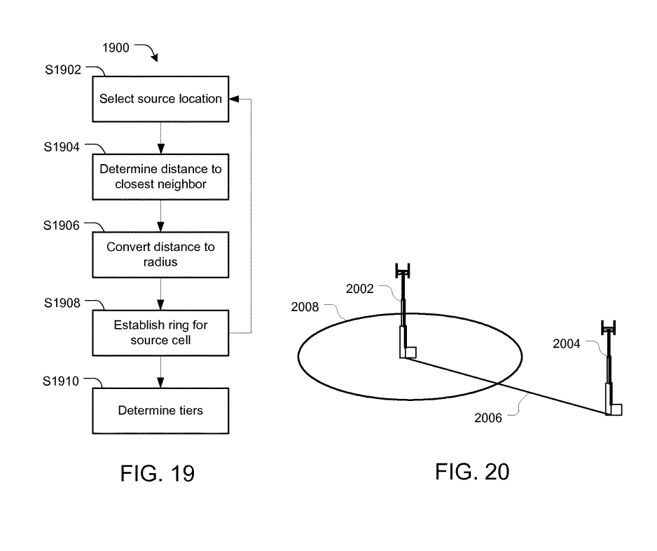

FIG. 19 shows another embodiment of a process 1900 for determining a tier relationship between cells. The shapes in process 1900 are circles, or rings. Accordingly, process 1900 may be referred to as a ring process.

A source location is selected at S1902. In an embodiment, the source location may be selected by selecting a cell point such as a cell point 714a of FIG. 7C, or by selecting a cell site such as cell site 502a of FIG. 7C. A cell site may be selected when the cell site is associated with an omnidirectional antenna, or for specific applications such as ANR optimizations.

The distance to a nearest neighbor location is determined at S1904. In an embodiment, the nearest neighbor is a cell that is the closest distance to the source cell that uses the same UTRA Absolute Radio Frequency Channel Number (UARFCN) layer as the source. When the source location is a cell point, the distance may be the distance to the closest cell point that is associated with a different cell site.

However, in other embodiments, cell site locations may be used as source locations. Such an embodiment is shown in FIG. 20, which shows a distance 2006 between source cell site 2002 and nearest neighboring cell site 2004. In an embodiment, a cell site may be used as a proxy for one or more cells that are associated with such a cell site. When the source location is a cell site, the distance may be the distance to the closest cell site that uses a same UARFCN as the source cell site.

The distance 2006 may be converted to a radius value of a ring 2008 by dividing the distance by two. The ring 2008 may be established at S1908 by creating a circle centered at source location 2002 with a radius from S1906. S1902 to S1908 may be repeated as many times as desired for locations in a wireless communications network.

A relationship between a source location 2002 and another location is determined at S1910. The relationship may be determined, for example, by establishing a line between a source location 2002 and a target location, and counting a number of rings 2008 that the line traverses other than the ring of the source location. In such an embodiment, a number of tiers between the source and target locations may be the number of rings other than the source ring.

Process 1900 is a useful alternative to using raw distance values to classify relationships between cell sites and/or individual cells. Raw distance does not account for variations in density, while process 1900 can establish relationships that do account for density. As such, process 1900 and other processes of this disclosure are more robust and useful than raw distance to a variety of cellular network technologies. In a specific embodiment, process 1900 may be used to determine unnecessary or problematic neighbor relations between cells by removing neighbor relations for which the number of tiers from S1910 is greater than a threshold value.

Embodiments of this disclosure may be used to determine which cells should be added to and removed from cellular neighbor lists; to determine what priority should be assigned to cells on neighbor lists; to disambiguate reuse codes that are detected by mobile devices in cellular networks; to set handover parameters and threshold values which are used for operations such as handovers and load balancing operations; and to classify cell types in networks into core cells and edge cells, where core cells have a coverage area surrounded by many other cells' coverage areas and edge cells have coverage areas that extend well beyond the areas served by the core cells.

For example, a system for initializing neighbor lists for new cells in cellular networks may use the first and second tier neighbors of a first cell identified by embodiments of this disclosure as the cells to be placed on the initial neighbor list of the first cell. Elements of this disclosure may affect a handover operation.

What is claimed is:

1. A computer-implemented method for determining a neighbor tier relationship between first and second cells in a wireless communications network that includes a plurality of cell sites, the method comprising:
establishing respective cell site shapes for the plurality of cell sites including the first and second cells, each shape representing a coverage area of a corresponding cell site;
establishing cell shapes for the cells of the plurality of cell sites;
determining a tier relationship between the first and second cells based on a number of cell polygons between the first and second cells; and
storing the tier relationship in a memory.

2. The method of claim 1, wherein establishing respective cell site shapes for the plurality of cell sites includes:
determining locations for each of the plurality of cell sites; and
creating a first Voronoi diagram using the cell site locations as seeds.

3. The method of claim 2, establishing cell shapes for the cells of the plurality of cell sites includes:
determining cell points for cells of the plurality of cell sites; and
creating a second Voronoi diagram using the cell points as seeds.

4. The method of claim 1, further comprising:
determining cell points for cells of the plurality of cell sites.

5. The method of claim 4, wherein determining cell points for cells of the plurality of cell sites includes:
determining a distance from a first cell site of the plurality of cell sites to a nearest neighboring cell site; and
establishing cell points for the first cell site at locations that are a fraction of the distance from the first cell site.

6. The method of claim 5, wherein the fraction of the distance is a value from 0.05 to 0.50.

7. The method of claim 4, wherein the cell points are established at azimuth directions for antennas of the first cell site.

8. The method of claim 4, wherein the nearest neighboring cell site is determined by performing Delaunay triangulation on the plurality of cell sites.

9. The method of claim 4, further comprising:
performing Delaunay triangulation on the cell points.

10. The method of claim 9, further comprising:
determining first tier relationships between cells associated with the cell points by identifying cells that are connected by a single leg of triangles from the Delaunay triangulation as first tier neighbors.

11. The method of claim 10, wherein determining first tier relationships is performed for all cells of the plurality of cell sites.

12. The method of claim 11, further comprising:
counting a number of first tier relationships between the first cell and the second cell, wherein the number of first tier relationships is the tier relationship between the first cell and the second cell.

13. The method of claim 9, wherein determining the tier relationship between the first and second cells includes determining a least number of triangle legs of the Delaunay triangles that connect the first cell to the second cell.

14. The method of claim 1, wherein the cell site shapes are Voronoi polygons.

15. The method of claim 14, wherein the cell shapes are Voronoi polygons.

16. The method of claim 15, wherein the tier relationship between the first cell and the second cell is determined based on a lowest number of Voronoi polygons between the first and second cells.

17. The method of claim 15, further comprising:
determining a lowest number of polygon edges that must be traversed between the first cell and the second cell, wherein the lowest number of polygon edges is a value of the tier relationship between the first and second cells.

18. The method of claim 14, further comprising:
establishing a line between one of first or second cell points corresponding to the first and second cells or first or second cell sites corresponding to the first and second cells; and
determining a number of cell shapes that intersect with the line,
wherein the number of cell shapes that intersect with the line is a value of the tier relationship between the first and second cells.

19. The method of claim 4, wherein, when a cell site uses an omnidirectional antenna, the cell point is the location of the cell site.

20. The method of claim 1, further comprising:
updating a neighbor list based on the tier relationship.
